(19) United States
(12) Patent Application Publication
(10) Pub. No.: US 2026/0172845 A1
(43) Pub. Date: Jun. 18, 2026

(54) AUTOMATIC COVERAGE ADJUSTMENT IN A HETEROGENOUS NETWORK WHICH INCLUDES A CITIZENS BROADBAND RADIO SERVICE NETWORK

(71) Applicant: Charter Communications Operating, LLC, St. Louis, MO (US)

(72) Inventors: Saran Khalid, Denver, CO (US); MohammedYusuf M. Shaikh, Aurora, CO (US)

(73) Assignee: Charter Communications Operating, LLC, St. Louis, MO (US)

(21) Appl. No.: 18/978,593

(22) Filed: Dec. 12, 2024

(51) Int. Cl. H04W 16/18; H04W 16/28; H04W 52/02

(52) U.S. Cl. CPC H04W 16/18; H04W 16/28; H04W 52/0206

(57) ABSTRACT

Methods and systems for wireless coverage adjustment in a system with Citizens Broadband Radio Service (CBRS). A method includes receiving, by a coverage adjustment engine from a spectrum access system (SAS), coverage reduction messages for one or more CBRS devices (CBSDs) in a wireless network, identifying, by the coverage adjustment engine, one or more coverage expansion base stations in the wireless network to mitigate an impact of wireless coverage area gaps resulting from the coverage reduction messages, and sending, by the coverage adjustment engine to each of the one or more coverage expansion base stations, expansion parameters to adjust an associated wireless coverage area to mitigate the wireless coverage area gaps, where adjustments to one or more associated wireless coverage areas are done prior to execution of the coverage reduction messages at the one or more CBSDs.

### TECHNICAL FIELD

This disclosure relates to wireless communications. More specifically, automatically adjusting wireless coverage due to wireless coverage gaps from a Citizens Broadband Radio Service (CBRS) power reduction or grant suspension.

### BACKGROUND

Wireless network operators can operate with or use multiple carriers to provide coverage and capacity for communications between devices. These multiple carriers can use licensed radio frequency spectrum for third generation (3G), fourth generation (4G), and fifth generation (5G) wireless communications, and unlicensed spectrum. Citizens Broadband Radio Service (CBRS) spectrum is a type of unlicensed spectrum or shared radio frequency spectrum which is shared between multiple entities including government users (such as the military), licensed users, and non-licensed users. CBRS is a multitiered wireless band between 3.550 MHz and 3.700 MHz. In particular, CBRS is a three-tiered access framework including incumbent users (i.e., federal, military, and the like), priority access users (winning auction bidders) who have Priority Access Licenses (PALs) to CBRS spectrum, and general authorized access (GAA) users, where the general users are permitted to use any portion of the CBRS spectrum not assigned to a higher tier user and may also operate opportunistically on unused priority access spectrum. Availability of CBRS spectrum dynamically changes depending on use by higher priority entities. Higher tier users are protected from lower tier users using a centralized spectrum access system (SAS), which may be a federal or commercial entity. The SAS authorizes or grants spectrum to access points known as CBRS Devices (CBSDs) and performs interference management to protect higher tier users. This protection may include, for example, dropping CBSDs which are general authorized access users. In summary, CBRS is an interference limited network which means that the performance of the network and the data sent to CBRS subscribers is limited by the amount of interference the CBRS users or subscribers experience in the frequency band of operation.

The multiple carriers using the licensed radio frequency spectrum and unlicensed spectrum form a heterogenous network, which can have a myriad of different coverage areas and/or patterns and coverage scenarios. That is, the coverage areas are non-homogenous and non-uniform. This can be further complicated if the deployed base stations are not co-located. In some instances, the CBSDs provide the primary coverage and other non-CBSD base stations provide no or little coverage. This can be problematic. For example, the SAS can suspend grant(s) at CBSD(s) when there is higher tier and/or incumbent usage on the CBRS spectrum being used by the CBSD(s), can reduce power, and/or combinations thereof. The CBSD(s) stop transmissions in response to receiving the grant suspension(s) and/or transmit at a lower power. This impacts the coverage area provided by the CBSD. This can result in, but not limited to, poor service, poor hand-offs, dropped calls, and/or combinations thereof.

### SUMMARY

Disclosed is a system and method for automatically adjusting wireless coverage areas to wireless coverage gaps from a Citizens Broadband Radio Service (CBRS) power reduction or grant suspension. In implementations, a method for wireless coverage adjustment in a system with Citizens Broadband Radio Service (CBRS) includes receiving, by a coverage adjustment engine from a spectrum access system (SAS), coverage reduction messages for one or more CBRS devices (CBSDs) in a wireless network, identifying, by the coverage adjustment engine, one or more coverage expansion base stations in the wireless network to mitigate an impact of wireless coverage area gaps resulting from the coverage reduction messages, and sending, by the coverage adjustment engine to each of the one or more coverage expansion base stations, expansion parameters to adjust an associated wireless coverage area to mitigate the wireless coverage area gaps. In implementations, the adjustments to one or more associated wireless coverage areas are done prior to execution of the coverage reduction messages at the one or more CBSDs.

### BRIEF DESCRIPTION OF THE DRAWINGS

The disclosure is best understood from the following detailed description when read in conjunction with the accompanying drawings. It is emphasized that, according to common practice, the various features of the drawings are not to scale. On the contrary, the dimensions of the various features are arbitrarily expanded or reduced for clarity.

FIG. 1 is a diagram of an example of a wireless network architecture in accordance with the teachings described herein.

FIG. 2 is a diagram of an example of an optimizer for heterogenous network with CBRS in accordance with the teachings described herein.

FIGS. 3A and 3B are a flow diagram of an example of a system for automatic wireless coverage adjustment based on spectrum access system reductions or suspensions in accordance with the teachings described herein.

FIG. 4 is a flow diagram of an example of a system for automatic wireless coverage adjustment based on spectrum access system reductions or suspensions in accordance with the teachings described herein.

FIG. 5 is a flow diagram of an example of a system for automatic wireless coverage adjustment based on spectrum access system reductions or suspensions in accordance with the teachings described herein.

FIGS. 6-8 are diagrams of an illustrative use case for automatic wireless coverage adjustment based on spectrum access system reductions or suspensions in accordance with the teachings described herein.

FIGS. 9-11 are diagrams of an illustrative use case for automatic wireless coverage adjustment based on spectrum access system reductions or suspensions in accordance with the teachings described herein.

FIGS. 9 and 12-13 are diagrams of an illustrative use case for automatic wireless coverage adjustment based on spectrum access system reductions or suspensions in accordance with the teachings described herein.

FIG. 14 is a flowchart of an example method for automatic wireless coverage adjustment based on spectrum access system reductions or suspensions in accordance with the teachings described herein.

FIG. 15 is a flowchart of an example method for automatic wireless coverage adjustment in accordance with the teachings described herein.

FIG. 16 is a block diagram of an example of a device in accordance with the teachings described herein.

### DETAILED DESCRIPTION

Reference will now be made in greater detail to embodiments, examples of which are illustrated in the accompanying drawings. Wherever possible, the same reference numerals will be used throughout the drawings and the description to refer to the same or like parts.

As used herein, the terminology “server”, “computer”, “computing device or platform”, or “cloud computing system” includes any unit, or combination of units, capable of performing any method, or any portion or portions thereof, disclosed herein. For example, the “server”, “computer”, “computing device or platform”, or “cloud computing system” may include at least one or more processor(s).

As used herein, the terminology “processor” or “processing circuitry” indicates one or more processors, such as one or more special purpose processors, one or more digital signal processors, one or more microprocessors, one or more controllers, one or more microcontrollers, one or more application processors, one or more central processing units (CPU)s, one or more graphics processing units (GPU)s, one or more digital signal processors (DSP)s, one or more application specific integrated circuits (ASIC)s, one or more application specific standard products, one or more field programmable gate arrays, any other type or combination of integrated circuits, one or more state machines, or any combination thereof.

As used herein, the term “engine” may include software, hardware, or a combination of software and hardware. An engine may be implemented using software stored in the memory subsystem. Alternatively, an engine may be hard-wired into processing circuitry. In some cases, an engine includes a combination of software stored in the memory and hardware that is hard-wired into the processing circuitry.

As used herein, the terminology “memory” indicates any computer-usable or computer-readable medium or device that can tangibly contain, store, communicate, or transport any signal or information that may be used by or in connection with any processor. For example, a memory may be one or more read-only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the term “memory” includes one or more memories, where each memory may be a computer-readable medium. A memory may encompass memory hardware units (e.g., a hard drive or a disk) that store data or instructions in software form. Alternatively or in addition, the memory may include data or instructions that are hard-wired into processing circuitry. The memory may include a single memory unit or multiple joint or disjoint memory units, which each of the multiple joint or disjoint memory units storing all or a portion of the data described as being stored in the memory.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. For example, the memory can be non-transitory. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the term “application” refers generally to a unit of executable software that implements or performs one or more functions, tasks, or activities. For example, applications may perform one or more functions including, but not limited to, telephony, web browsers, e-commerce transactions, media players, scheduling, management, smart home management, entertainment, and the like. The unit of executable software generally runs in a predetermined environment and/or a processor.

As used herein, the terminology “determine” and “identify,” or any variations thereof includes selecting, ascertaining, computing, looking up, receiving, determining, establishing, obtaining, or otherwise identifying or determining in any manner whatsoever using one or more of the devices and methods are shown and described herein.

As used herein, the terminology “example,” “the embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

As used herein, unless explicitly stated otherwise, any term specified in the singular may include its plural version. For example, “a computer that stores data and runs software,” may include a single computer that stores data and runs software or two computers - a first computer that stores data and a second computer that runs software. Also “a computer that stores data and runs software,” may include multiple computers that together stored data and run software. At least one of the multiple computers stores data, and at least one of the multiple computers runs software.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure and claims. Although aspects, features, and elements are described herein in particular combinations, each aspect, feature, or element may be used independently or in various combinations with or without other aspects, features, and elements.

Further, the figures and descriptions provided herein may be simplified to illustrate aspects of the described teachings and/or embodiments that are relevant for a clear understanding of the herein disclosed processes, machines, and/or manufactures, while eliminating for the purpose of clarity other aspects that may be found in typical similar devices, systems, and methods. Those of ordinary skill may thus recognize that other elements and/or steps may be desirable or necessary to implement the devices, systems, and methods described herein. However, because such elements and steps do not facilitate a better understanding of the disclosed teachings and/or embodiments, a discussion of such elements and steps may not be provided herein. However, the present disclosure is deemed to inherently include all such elements, variations, and modifications to the described aspects that would be known to those of ordinary skill in the pertinent art in light of the discussion herein.

Described herein is a system and method for method for automatic wireless coverage adjustment based on spectrum access system reductions or suspensions for a Citizens Broadband Radio Service (CBRS) device in a CBRS system.

In implementations, an optimizer for heterogenous network with CBRS networks (OHNC) and/or coverage adjustment engine can establish baseline coverage areas for a wireless network. The OHNC can determine coverage area gaps in response to and/or receipt of a spectrum access system (SAS) grant suspension and/or power reduction message and/or command (collectively “coverage reduction message”) with respect to one or more CBRS devices (CBSD(s)). The terms “coverage area gaps,” “wireless coverage gaps,” and/or similar language can refer to actual gaps in coverage, areas having poor coverage as evidenced by call drops, poor quality on calls, and/or call metrics, and/or combinations thereof. The OHNC engine can then determine which non-CBSD base stations can be used to provide coverage in the determined coverage area gaps. The OHNC engine can use network and/or base station statistics to determine which non-CBSD base stations can be used and to what extent they can be used to remedy the coverage in the coverage area gaps and/or mitigate and/or lessen the impact of the coverage area gaps. That is, the coverage being provided by the non-CBSD base stations can be expanded into the determined coverage area gaps. In implementations, this expansion coverage determination can be done prior to the CBSD(s) actually executing the requested coverage reduction. In implementations, this expansion coverage determination can be done to minimize loss of connectivity (i.e., the determined coverage area gaps) when the CBSD(s) actually execute the requested coverage reduction. In implementations, this expansion coverage determination can be done at a time substantially near to when the CBSD(s) actually execute the requested coverage reduction to minimize and/or mitigate loss of connectivity, i.e., the determined coverage area gaps. In implementations, the CBSD(s) have a defined period of time to execute the requested coverage reduction. In implementations, the defined period of time is 300 seconds. In implementations, the OHNC engine can compare network and/or base station statistics prior to and after expansion coverage is provided to determine impact on the network and/or base station statistics due to the expansion coverage. In implementations, the OHNC engine can adjust the expansion coverage based on the comparison. In implementations, the OHNC engine can restore original coverage area in response to a restoration message from the SAS.

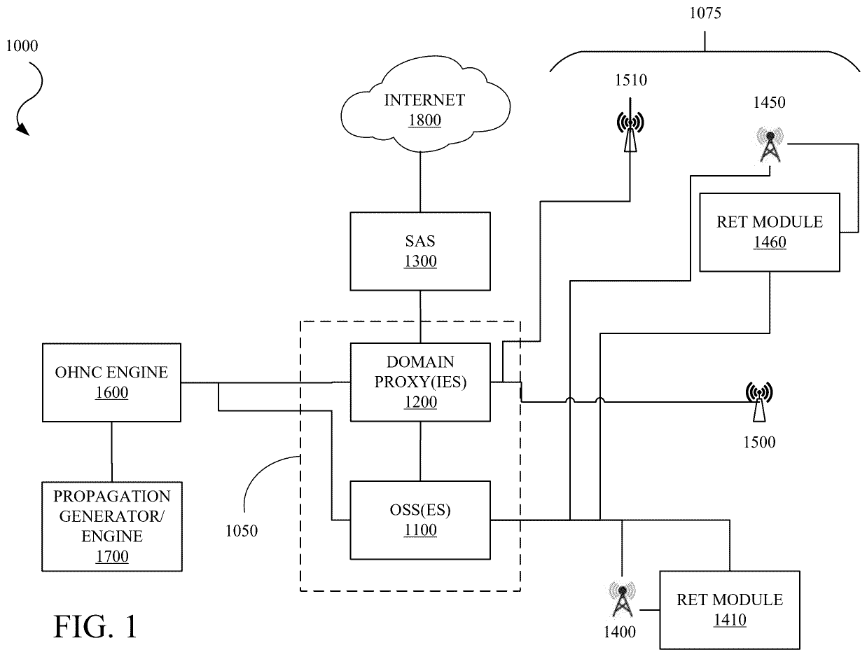

FIG. 1 is a diagram of an example wireless network architecture 1000 in accordance with the teachings described herein. The wireless network architecture 1000 can include, but is not limited to, a service provider system 1050, a wireless or cellular system or network (collectively “wireless system”) 1075, a SAS 1300, an OHNC and/or coverage adjustment engine and/or controller 1600, and/or a propagation generator and/or engine 1700. The wireless network architecture 1000 can implement any wireless technology including, but not limited to, third generation (3G), fourth generation (4G), and fifth generation (5G) wireless communications and/or networks, and CBRS or shared spectrum wireless technologies and/or networks. In implementations, the wireless network architecture 1000 can be a multiple systems operator (MSO) network, a hybrid mobile virtual network operator (HMNO) network where a service provider, which owns and operates the service provider system 1050, can operate the wireless system 1075 as a mobile virtual network operator (MVNO), and/or combinations thereof. The number of components shown herein are illustrative and there may be more or less in the wireless network architecture 1000. The wireless network architecture 1000 and the components therein may include other elements which may be desirable or necessary to implement the devices, systems, and methods described herein. However, because such elements and steps do not facilitate a better understanding of the disclosed teachings and/or embodiments, a discussion of such elements and steps may not be provided herein.

In implementations, the wireless system 1075 can include various functional components to address mobility management, authentication, session management, and other related functions with respect to, for example, one or more base stations 1400 and 1450 and one or more CBSDs 1500 and 1510. Each of the one or more base stations 1400 and 1450 and one or more CBSDs 1500 and 1510 can be an access point, an access node, a gNodeB, cable modem/router/integrated devices, small cell base stations, low-powered cellular radio access nodes, small, low-power base stations, and/or like device which enables radio communications access between a mobile device and other devices in wireless coverage areas associated with the one or more base stations 1400 and 1450 and one or more CBSDs 1500 and 1510, respectively. Each of the one or more base stations 1400 and 1450 can support wireless communications via one or more of the 3G, the 4G, and the 5G wireless technologies and/or networks and via CBRS wireless technologies and/or networks, where the SAS 1300 has granted or authorized CBRS spectrum (e.g., a channel(s)), and the one or more CBSDs 1500 and 1510 can support wireless communications via CBRS wireless technologies and/or networks, where the SAS 1300 has granted or authorized CBRS spectrum (e.g., a channel(s)).

In implementations, each of the one or more base stations 1400 and 1450 can have remote electrical tilt systems 1410 and 1460, respectively. The remote electrical tilt systems 1410 and 1460 can be used to automatically change a tilt of an associated base station to change a size, height, shape, and/or other characteristics of the wireless coverage area provided by the base station. In implementations, a transmit power of the one or more base stations 1400 and 1450 can also be changed to change a size, height, shape, and/or other characteristics of the wireless coverage area provided by the base station. In implementations, the size, height, shape, and/or other characteristics of the wireless coverage area provided by the base station can be changed using the remote electrical tilt systems 1410, power control and/or limitation, and/or combinations thereof.

The service provider system 1050 can include various functional components to address coverage areas, mobility management, authentication, session management, and other related functions with respect to, for example, the one or more base stations 1400 and 1450 and one or more CBSDs 1500 and 1510. The service provider system 1050 can include, but is not limited to, an operations support system (OSS) 1100 and a domain proxy (DP) 1200. In implementations, the service provider system 1050 can include the OHNC engine 1600, and/or the propagation generator 1700. In implementations, the service provider can have PAL licenses and can operate on GAA in a CBRS network.

The OSS 1100 can provide data, statistics, and/or related information with respect to base stations, traffic, and/or other components in the wireless system 1075. The OSS 1100 can work with the wireless system 1075, the DP 1200, the OHNC engine 1600, the propagation generator 1700, and/or other components in the service provider system 1050 to adjust wireless coverage areas when one or more CBSDs are suspended or requested to operate with reduced power by the SAS 1300. The OSS 1100 can work with the wireless system 1075, the DP 1200, the OHNC engine 1600, the propagation generator 1700, and/or other components in the service provider system 1050 to restore wireless coverage areas when one or more CBSDs are restored by the SAS 1300.

The DP 1200 can work with the SAS 1300, the OSS 1100, and the one or more CBSDs 1500 and 1510 with respect to messages sent by the SAS 1300 as described herein. For example, the messages can be related to grant, grant suspension, power reduction, and/or combinations thereof with respect to the one or more CBSDs 1500 and 1510.

The SAS 1300 enables access to the CBRS spectrum and dynamically manages the spectrum for optimal use, efficiency, and compliance with CBRS rules. The SAS 1300 communicates with each base station which supports CBRS for registration, grant allocation/deallocation, and interference management. The SAS 1300 can perform interference analysis based on the power measurements received from mobile device(s) and make allocation and deallocation decisions based on the interference. The SAS 1300 may be operated by a commercial, federal entity, or some combinations thereof. The SAS 1300 can be connected to the internet 1800 to provision the CBRS rules, for example.

The propagation engine 1700 can determine a wireless coverage area for each base station in the wireless system 1075. The wireless coverage area represents the area that the base station can reach and provide service. Different propagation models can be used in combination with digital terrain, morphologies, buildings and/or morphology heights data. In implementations, the propagation engine 1700 can part of the service provider system 1050, a standalone system, and/or combinations thereof.

The OHNC engine 1600 can automatically provision wireless coverage are expansion into coverage area gaps due to coverage reduction messages from the SAS 1300. The OHNC engine 1600 can work with the OSS 1100 and the propagation engine 1700 to establish baseline wireless coverage areas. The OHNC engine 1600 can work with the DP 1200 to receive coverage reduction related messages from the SAS 1300. The OHNC engine 1600 can review the coverage reduction related messages and work with the propagation engine 1700 to determine wireless coverage gaps based on the affected CBSDs and/or base stations. The OHNC engine 1600 can work with the OSS 1100 to establish baseline statistics, which can be used to determine which base stations can be used to expand wireless coverage areas into the wireless coverage gaps, and inform the appropriate base stations. In implementations, the OHNC engine 1600 can work with the OSS 1100 with to determine changes in the statistics and implement additional changes at the one or more base stations, as needed, to balance and/or trade-off wireless coverage areas and statistics. In a non-limiting example, the OHNC engine 1600 can compare the change in one or more statistics against a defined threshold(s). For example, the defined threshold can be a 1% change in one or more statistics. For example, the defined threshold can be a 2% change in one or more statistics.

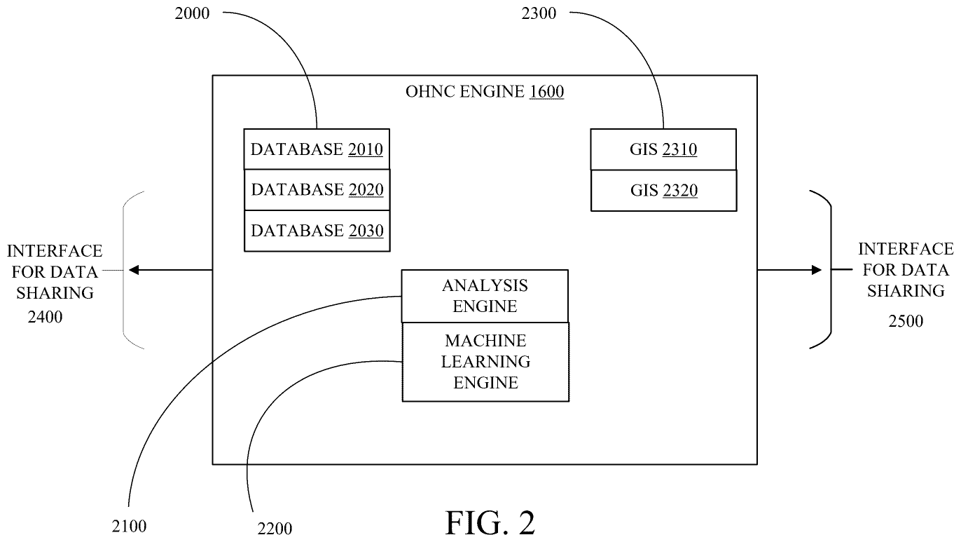

In implementations, the OHNC engine 1600 can be a server, a cloud based platform, distributive, virtual machines, and/or combinations thereof. FIG. 2 is a diagram of an example of the OHNC engine 1600 in accordance with the teachings described herein. In implementations, the OHNC engine 1600 can include a database 2000, an analytics engine 2100, a machine learning engine 2200, and a Geographic Information System (GIS) 2300, and interfaces 2400 and 2500. In implementations, the OHNC engine 1600 can part of the service provider system 1050, a standalone system, and/or combinations thereof.

In implementations, the database 2000 can be for storing records, data, statistics, wireless coverage areas, defined thresholds, and other related information as obtained from different network entities, generated by the OHNC engine 1600, and/or combinations thereof. In implementations, the database 2000 can be partitioned for optimized performance.

In implementations, the analytics engine 2100 and the machine learning engine 2200 can be to perform, but not limited to, comparative analysis, base station determinations, wireless coverage area gap determinations, wireless coverage expansion parameter changes to base stations, and/or historical analysis based on prior wireless coverage expansion parameter changes. In implementations, the wireless coverage area gap determinations can be optimized based on comparison of statistics as described herein. In a non-limited example, the machine learning engine 2200 can be trained to determine the wireless coverage expansion parameter changes based on wireless coverage area gaps, previous wireless coverage expansion parameter changes, previous adjustments made due to statistics comparisons, and/or factors.

In implementations, the GIS 2300 can be used to provide geographic information and/or details with respect to wireless coverage areas, wireless coverage area gaps, changes in the wireless coverage areas with respect to wireless coverage expansion parameter changes, and/or other information. This can be presented, for example, as visual information to a user.

In implementations, the interfaces 2400 and 2500 can be used to exchange data with other systems and/or components as described herein.

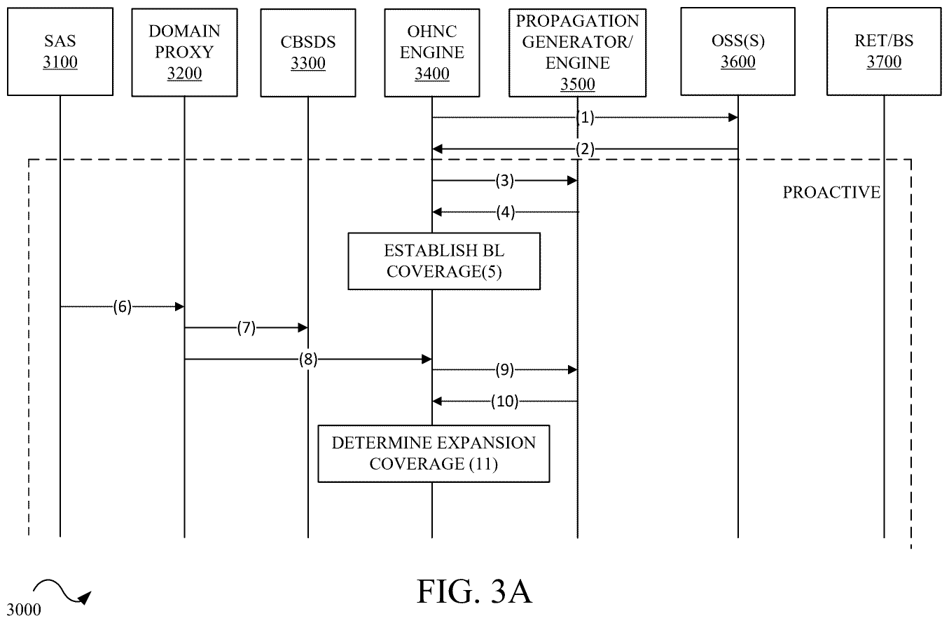

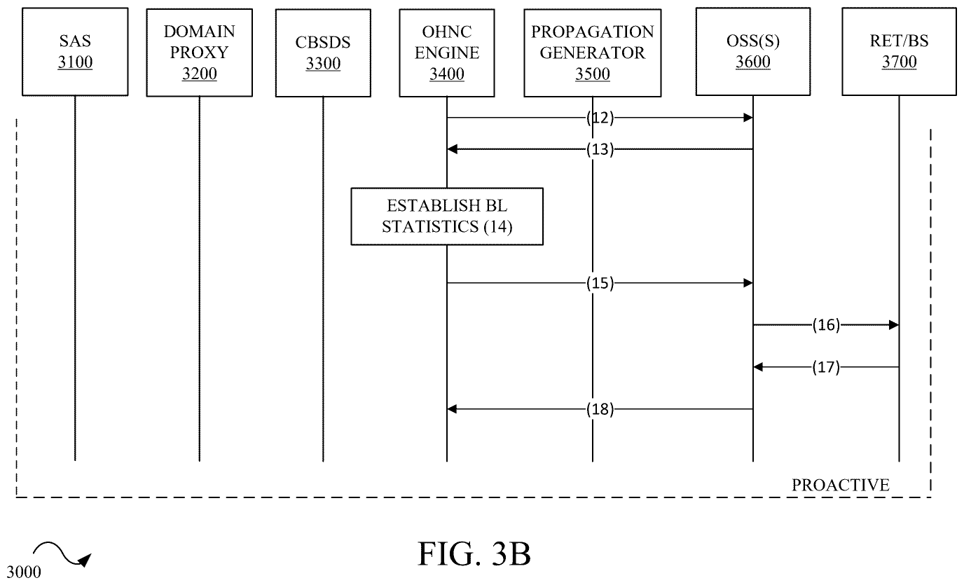

FIGS. 3A and 3B are a flow 3000 of an example of a system using automatic wireless coverage adjustment based on SAS reductions or suspensions for a CBSD in a CBRS system. The flow 3000 is performed between a SAS 3100, a DP 3200, one or more CBSD(s) 3300, an OHNC engine 3400, a propagation engine 3500, one or more OSS(s) 3600, and one or more base station(s) 3700. In implementations, the base station 3700 can include a remote electrical tilt system. In implementations, the flow 3000 can be done automatically by the system in response to a coverage reduction message such that expansion wireless coverage is provided prior to implementation of the coverage reduction message by an affected CBSD. This processing can be referred to as proactive processing in response to the coverage reduction message. Each of the components listed in FIG. 3 can function as described herein with respect to FIGS. 1 and 2.

In the flow 3000, the OHNC engine 3400 can request base station and/or sites data and configuration data from the one or more OSS(es) 3600 (1). The one or more OSS(es) 3600 can provide the requested data to the OHNC engine 3400 (2). The OHNC engine 3400 can provide the base station data and configuration data to the propagation engine 3500 (3). The base station data and configuration data can include, but is not limited to, base stations, transmit power, and/or other data needed by the propagation engine 3500 to determine wireless coverage areas. The propagation engine 3500 can provide the wireless coverage areas to the OHNC engine 3400 (4), which can save the information as baseline wireless coverage areas (5). For example, this can be saved in the database 2000 of FIG. 2.

In implementations, the SAS 3100 can send a coverage reduction message, such as a grant suspension and/or power reduction message, to the DP 3200 (6). The DP 3200 can forward the coverage reduction message to each of affected one or more CBSD(s) 3300 (7) and to the OHNC engine 3400 (8). The OHNC engine 3400 can provide a list of the affected one or more CBSD(s) 3300 to the propagation engine 3500 (9). The list can detail whether the CBSD is suspended, a new power level from the SAS 3100, and/or other information needed to determine the new wireless coverage areas. The propagation engine 3500 can provide the new or affected wireless coverage areas to the OHNC engine 3400 (10). The OHNC engine 3400 can determine wireless coverage area gaps by comparing the baseline wireless coverage areas with the new or affected wireless coverage areas (11). The OHNC engine 3400 can identify base stations, non-affected CBSDs, and/or combinations thereof (collectively “expansion coverage base stations”) which may be used to provide expansion coverage to mitigate the wireless coverage area gaps. The OHNC engine 3400 can request and/or obtain statistics data from the OSS(es) 3600 for base stations and/or non-affected CBSDs which are neighbors to the expansion coverage base stations (collectively “neighbor base stations”) (12). The OSS(es) 3600 can provide the neighbor base stations statistics data to the OHNC engine 3400 (13), which can save the information as baseline statistics data (14). For example, this can be saved in the database 2000 of FIG. 2. The OHNC engine 3400 can provide the list of expansion coverage base stations to OSS(es) 3600 (15). The list can include, but is not limited to, wireless coverage expansion parameter changes for each of the expansion coverage base stations on the list. The OSS(es) 3600 can provide the wireless coverage expansion parameter changes to each of the expansion coverage base stations on the list (16), which in turn can implement the wireless coverage expansion parameter change. For example, an expansion coverage base station can increase power, change a tilt position, and/or combinations thereof. Each of the expansion coverage base stations can send a confirmation message to the OSS(es) 3600 that the wireless coverage expansion parameter change has been implemented (17). The OSS(es) 3600 can send the confirmation message to the OHNC engine 3400 (18).

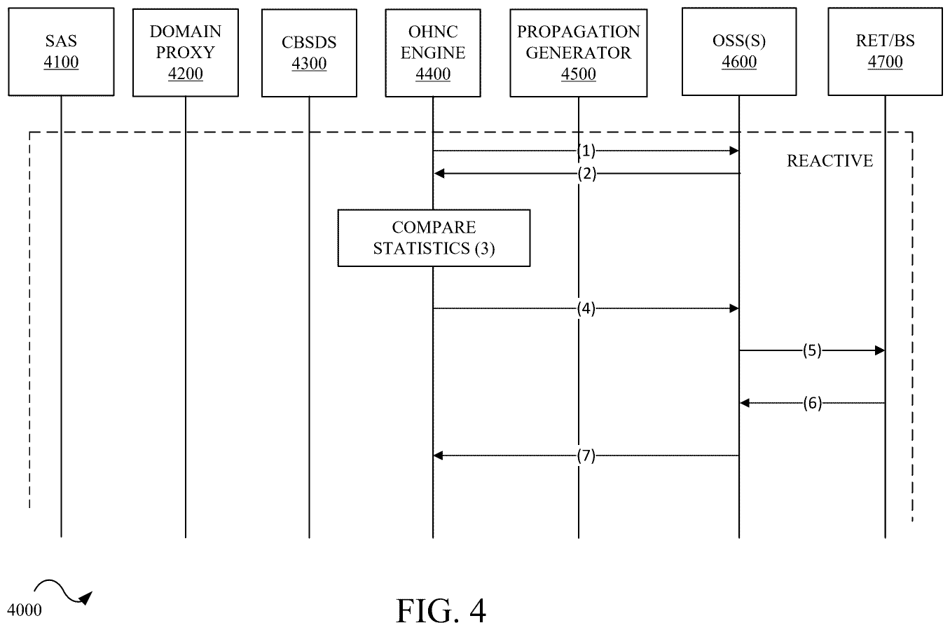

FIG. 4 is a flow 4000 of an example of a system using automatic wireless coverage adjustment based on SAS reductions or suspensions for a CBSD in a CBRS system. The flow 4000 is performed between an OHNC engine 4400, a propagation engine 4500, one or more OSS(s) 4600, and one or more base station(s) 4700. Other components, such as a SAS 4100, a DP 4200, one or more CBSD(s) 3300, are shown for completeness and context. In implementations, the base station 4700 can include a remote electrical tilt system. In implementations, the flow 4000 can be done automatically by the system to assess impact of wireless coverage expansion parameter changes made in response to a coverage reduction message to one or more CBSD(s). This processing can be referred to as reactive processing in response to the coverage reduction message. Each of the components listed in FIG. 4 can function as described herein with respect to FIGS. 1 and 2. The flow 4000 can be done in association with the flow 3000 of FIG. 3.

In the flow 4000, the OHNC engine 4400 can request and/or obtain statistics data from the OSS(es) 4600 for neighbor base stations (as described in the flow 3000) (1). The OSS(es) 4600 can provide the neighbor base stations statistics data to the OHNC engine 4400 (2), which can save the information in the database 2000 of FIG. 2, for example. The OHNC engine 4400 can compare the neighbor base stations statistics data to the baseline neighbor base stations statistics data to determine the impact of the wireless coverage expansion parameter changes (3). The OHNC engine 4400 can optimize and/or adjust the wireless coverage expansion parameter changes based on statistics degradation using defined thresholds. The OHNC engine 4400 can provide the list of expansion coverage base stations to OSS(es) 4600 (4). The list can include, but is not limited to, adjusted or optimized wireless coverage expansion parameter changes for each of the expansion coverage base stations on the list. The OSS(es) 4600 can provide the adjusted or optimized wireless coverage expansion parameter changes to each of the expansion coverage base stations on the list (5), which in turn can implement the adjusted or optimized wireless coverage expansion parameter change. For example, an expansion coverage base station can increase and/or decrease power, change a tilt position, and/or combinations thereof. Each of the expansion coverage base stations can send a confirmation message to the OSS(es) 4600 that the wireless coverage expansion parameter change has been implemented (6). The OSS(es) 4600 can send the confirmation message to the OHNC engine 4400 (7).

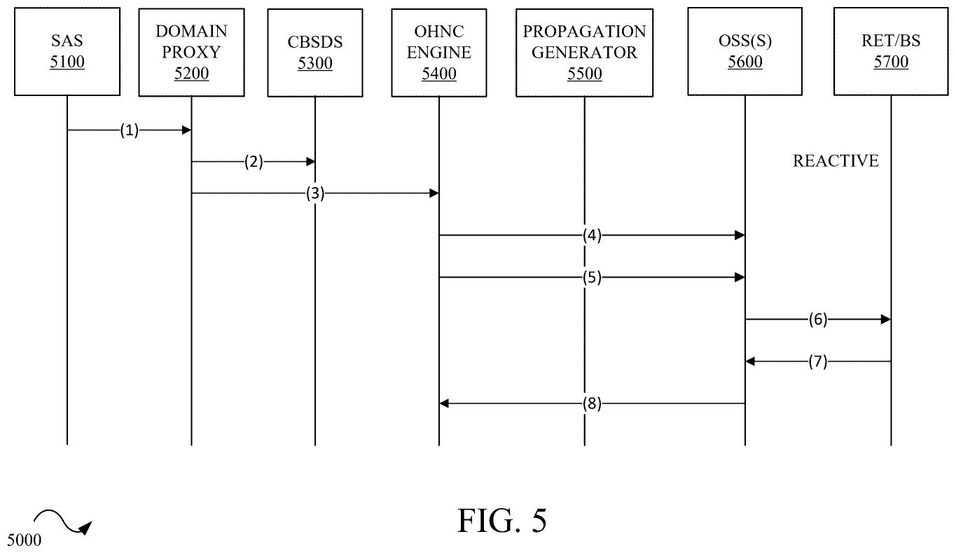

FIG. 5 is a flow 5000 of an example of a system using automatic wireless coverage adjustment based on SAS reductions or suspensions for a CBSD in a CBRS system. The flow 5000 is performed between a SAS 5100, a DP 5200, one or more CBSD(s) 5300, an OHNC engine 5400, one or more OSS(s) 5600, and one or more base station(s) 5700. A propagation engine 5500 is shown for completeness and context. In implementations, the base station 5700 can include a remote electrical tilt system. In implementations, the flow 5000 can be done automatically by the system to assess impact of wireless coverage expansion parameter changes made in response to a coverage reduction message to one or more CBSD(s). Each of the components listed in FIG. 5 can function as described herein with respect to FIGS. 1 and 2. The flow 5000 can be done in association with the flow 3000 of FIG. 3 and the flow 4000 of FIG. 4.

In the flow 5000, the SAS 5100 can send a restore message, such as a grant and/or power restoral message, to the DP 5200 (1). The DP 5200 can forward the restore message to each of affected one or more CBSD(s) 5300 (now “restored one or more CBSD(s) 5300”) (2) and to the OHNC engine 5400 (3). The OHNC engine 3400 can send a list of restored CBSD(s) to the OSS(es) 5600 (4). This enables the OSS(es) 5600 to start the process to restore the expansion coverage base station(s) to previous configuration. The OHNC engine 3400 can provide a list of base station(s) to the OSS(es) 5600 (5). The list can include, but is not limited to, wireless coverage restoration parameter changes for each base station for which wireless coverage expansion parameter changes were made. For example, the wireless coverage restoration parameter changes can include, but is not limited to, power changes, tilt changes, and/or combinations thereof. The OSS(es) 5600 can send and/or provide the wireless coverage restoration parameter changes to each of the base stations on the list (6), which in turn can implement the wireless coverage restoration parameter change. For example, a base station can increase and/or decrease power, change a tilt position, and/or combinations thereof. Each of the base stations can send a confirmation message to the OSS(es) 5600 that the wireless coverage restoration parameter change has been implemented (7). The OSS(es) 5600 can send the confirmation message to the OHNC engine 5400 (8).

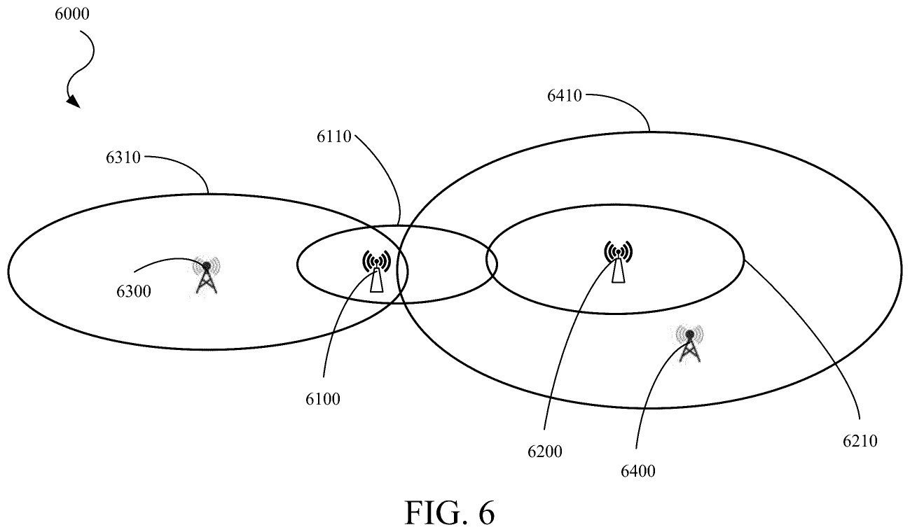

FIGS. 6-8 are diagrams of an illustrative use case for automatic wireless coverage adjustment based on spectrum access system reductions or suspensions in accordance with the teachings described herein.

In FIG. 6, a system 6000 includes a CBSD 6100 with a wireless coverage area 6110, a CBSD 6200 with a wireless coverage area 6210, a base station 6300 with a wireless coverage area 6310, and a base station 6400 with a wireless coverage area 6410. As shown, the CBSD 6100 can provide connecting wireless coverage between the base station 6300 and the base station 6400, which assists and/or enables, in part, handover of mobile devices between the base station 6300 and the base station 6400. The CBSD 6200 can provide capacity wireless coverage for the base station 6300.

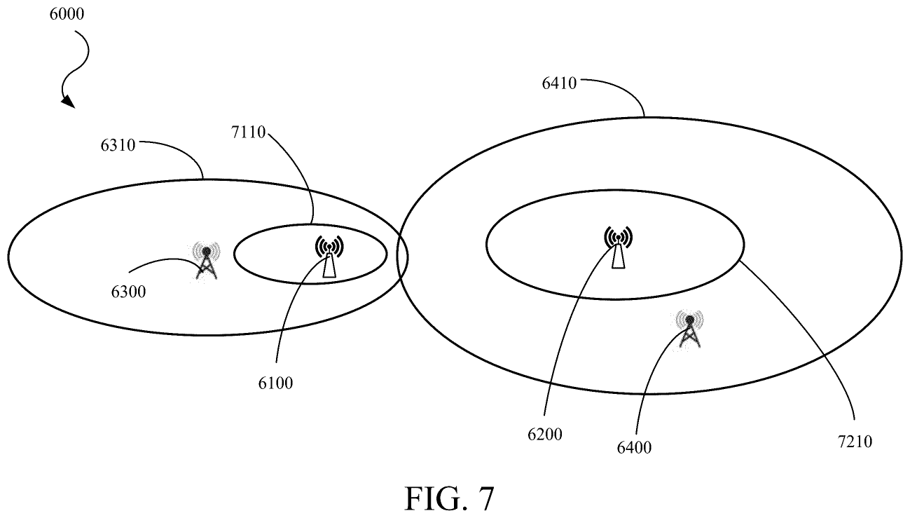

In FIG. 7, a SAS initiates a power reduction via a coverage reduction message. This can cause the wireless coverage areas 6110 and 6210, for example, to shrink to wireless coverage areas 7110 and 7210. As a result, calls on mobile devices transitioning between the base stations 6300 and 6400 may drop off, may ping-pong between the base stations 6300 and 6400, and/or suffer other poor call quality. That is, the shrinkage may result in poor coverage and user experience.

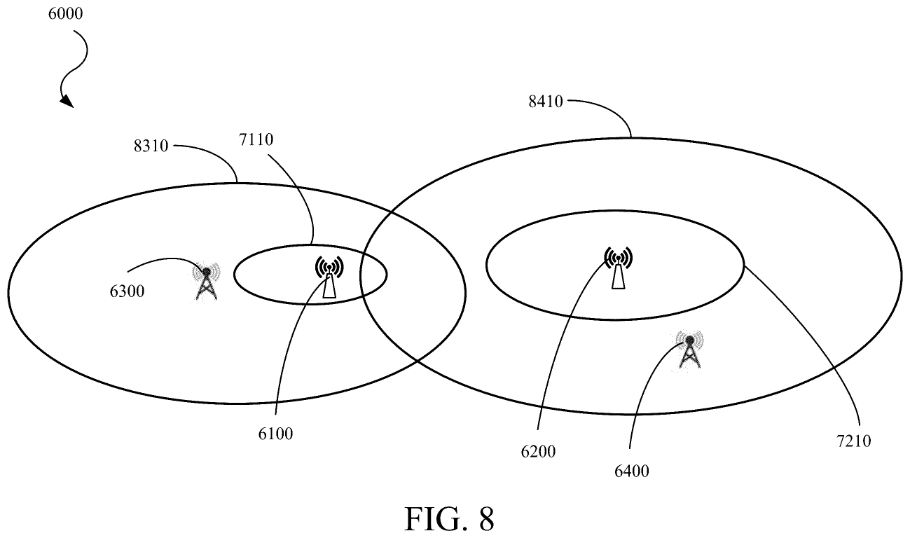

In FIG. 8, the system can use the automatic wireless coverage adjustment methods described herein to enhance the wireless coverage areas of the base stations 6300 and 6400 to cover the shrinkage in the wireless coverage areas of the CBSDs 6100 and 6200. For example, as a result of the automatic wireless coverage adjustment methods, the base stations 6300 and 6400 now have extended or expanded wireless coverage areas 8310 and 8410, for example. The wireless coverage areas 8310 and 8410 mitigate the shrunken wireless coverage areas 7110 and 7210 of the CBSDs 6100 and 6200.

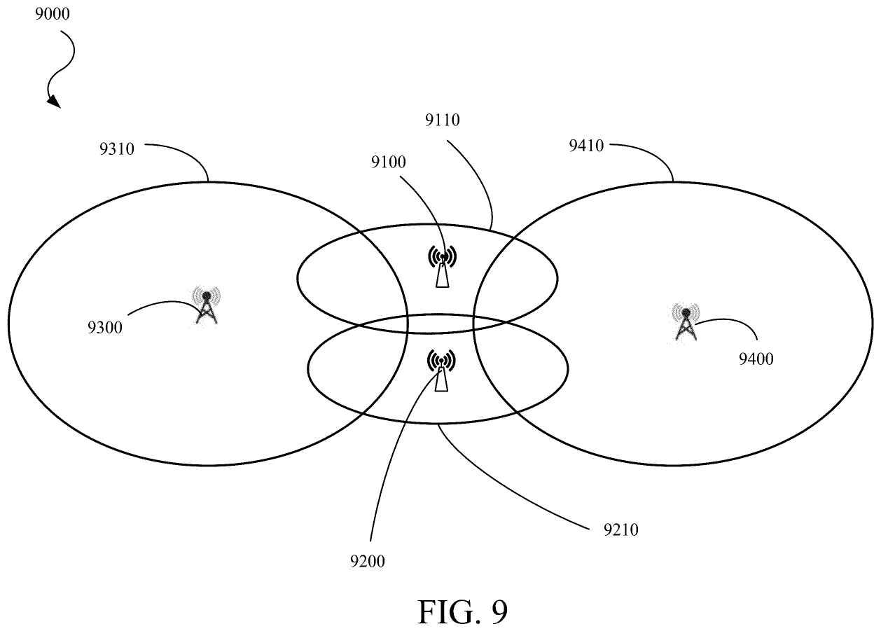

FIGS. 9-11 are diagrams of an illustrative use case for automatic wireless coverage adjustment based on spectrum access system reductions or suspensions in accordance with the teachings described herein.

In FIG. 9, a system 9000 includes a CBSD 9100 with a wireless coverage area 9110, a CBSD 9200 with a wireless coverage area 9210, a base station 9300 with a wireless coverage area 9310, and a base station 9400 with a wireless coverage area 9410. As shown, the CBSDs 9100 and 9200 can provide connecting wireless coverage between the base station 9300 and the base station 9400, which assists and/or enables, in part, handover of mobile devices between the base station 9300 and the base station 9400.

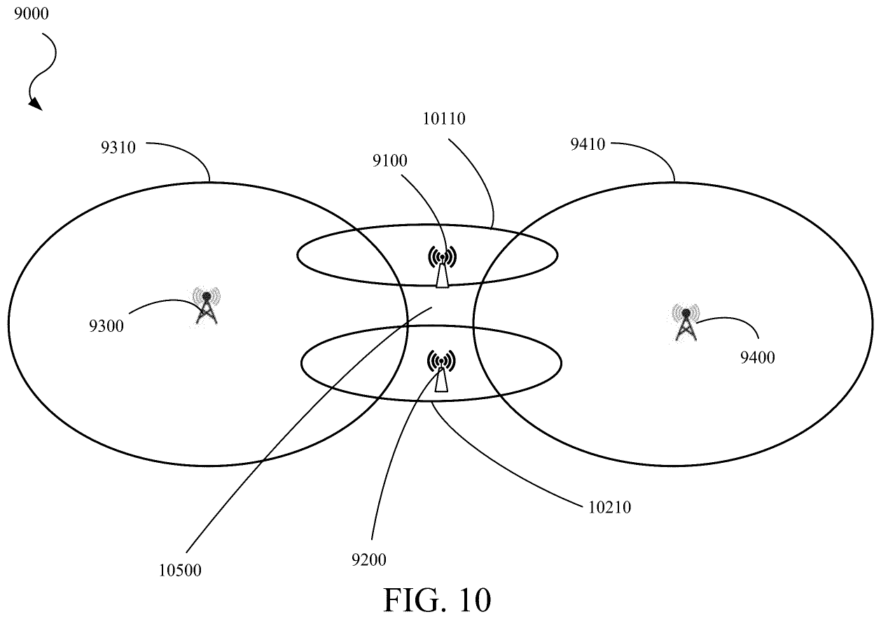

In FIG. 10, a SAS initiates a power reduction via a coverage reduction message. This can cause the wireless coverage areas 9110 and 9210, for example, to shrink to wireless coverage areas 10110 and 10210. As a result, calls on mobile devices transitioning between the base stations 9300 and 9400 may drop off, may ping-pong between the base stations 9300 and 9400, and/or suffer other poor call quality. That is, the shrinkage may result in poor coverage and user experience. Moreover, the shrinkage can result in a coverage area gap 10500, for example.

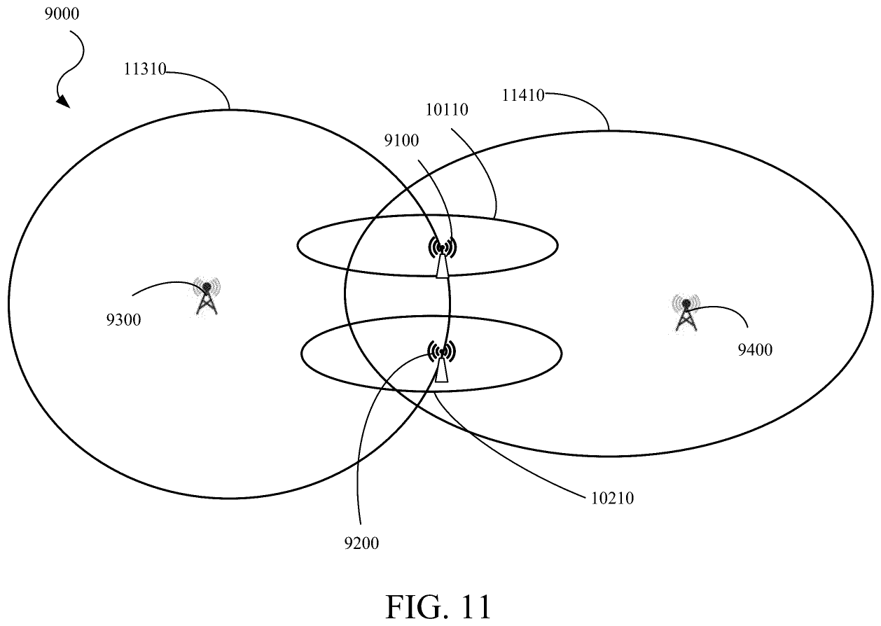

In FIG. 11, the system can use the automatic wireless coverage adjustment methods described herein to enhance the wireless coverage areas of the base stations 9300 and 9400 to cover the shrinkage in the wireless coverage areas of the CBSDs 9100 and 9200. For example, as a result of the automatic wireless coverage adjustment methods, the base stations 9300 and 9400 now have extended or expanded wireless coverage areas 11310 and 11410, for example. The wireless coverage areas 11310 and 11410 mitigate the shrunken wireless coverage areas 10110 and 10210 of the CBSDs 9100 and 9200.

FIGS. 9 and 12-13 are diagrams of an illustrative use case for automatic wireless coverage adjustment based on spectrum access system reductions or suspensions in accordance with the teachings described herein.

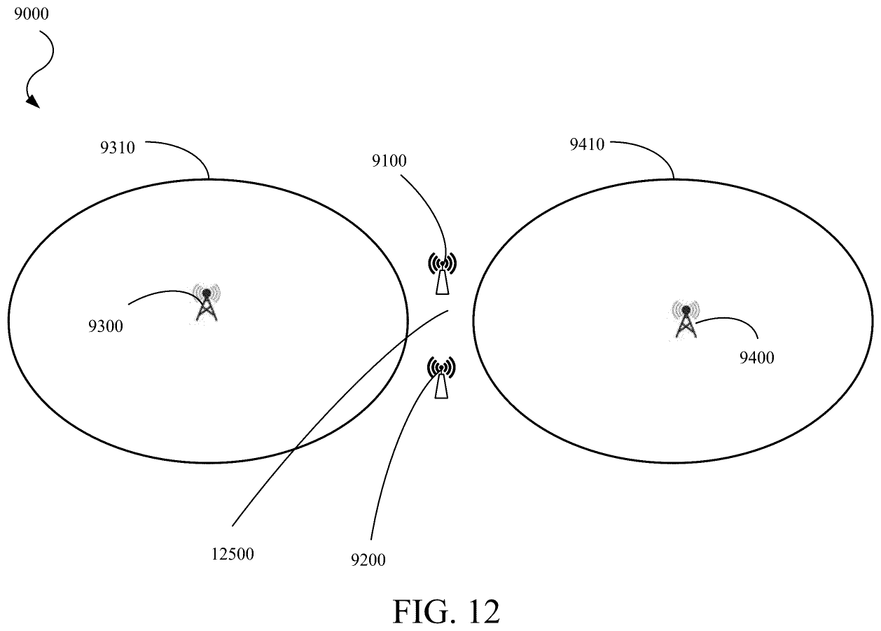

In FIG. 12, a SAS initiates a grant suspension via a coverage reduction message. This can cause the wireless coverage areas 9110 and 9210, for example, to disappear and result in a coverage area gap 12500. Consequently, calls on mobile devices transitioning between the base stations 9300 and 9400 will drop off. That is, there will be no coverage for users of mobile devices.

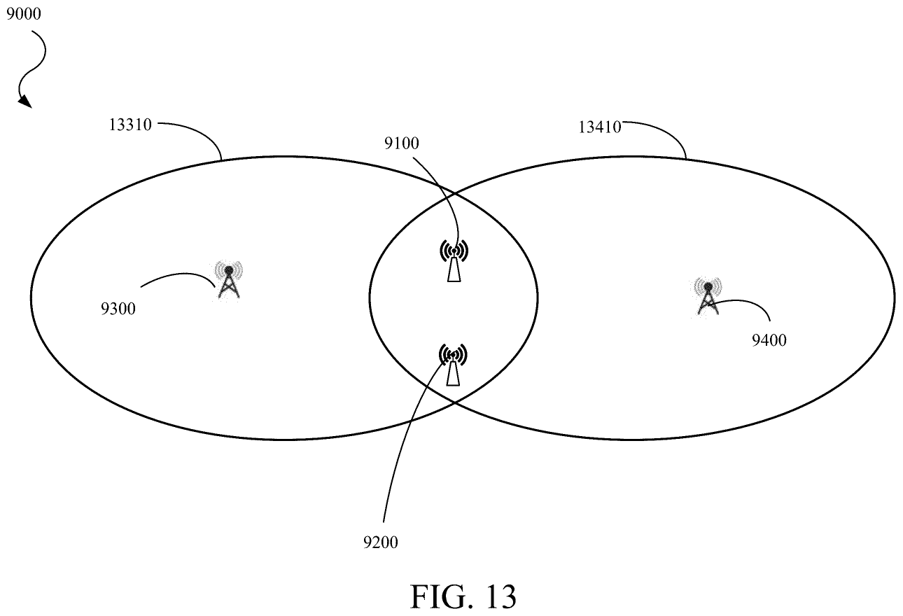

In FIG. 13, the system can use the automatic wireless coverage adjustment methods described herein to enhance the wireless coverage areas of the base stations 9300 and 9400 to cover the loss of the wireless coverage areas of the CBSDs 9100 and 9200. For example, as a result of the automatic wireless coverage adjustment methods, the base stations 9300 and 9400 now have extended or expanded wireless coverage areas 13310 and 13410, for example. The wireless coverage areas 13310 and 13410 mitigate the loss of the wireless coverage areas 9110 and 9210 of the CBSDs 9100 and 9200.

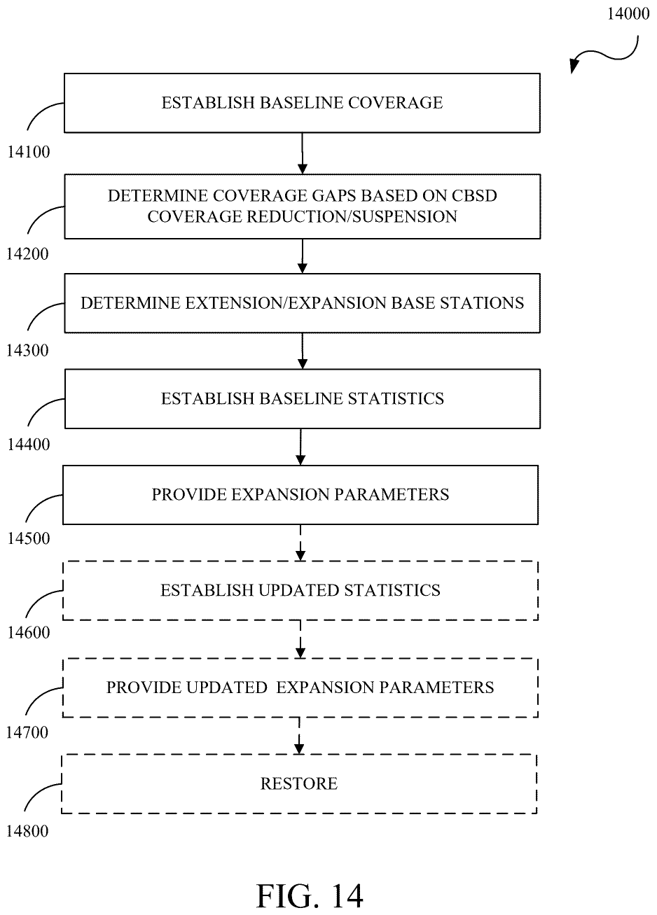

FIG. 14 is a flowchart of an example method 14000 for automatic wireless coverage adjustment based on spectrum access system reductions or suspensions in accordance with the teachings described herein. The method 14000 includes: establishing 14100 baseline wireless coverage areas; determining 14200 coverage area gaps due to CBSD coverage reduction; determining 14300 coverage expansion base stations; establishing 14400 baseline statistics for neighbor base stations; providing 14500 expansion parameters; establishing 14600 updated baseline statistics for neighbor base stations; providing 14700 updated expansion parameters; and restoring 14800 baseline wireless coverage areas. The method 14000 can be implemented, for example, in or by components described with respect to FIGS. 1-2 and 16 and in conjunction with any of the flows described with respect to FIGS. 3A-13 and 15, as appropriate and applicable.

The method 14000 includes establishing 14100 baseline wireless coverage areas. A system collects data from one or more OSS(es) and works with a propagation engine to determine baseline wireless coverage areas for base stations. The base stations can include CBSD(s) which support CBRS spectrum, and base stations which support licensed spectrum. In implementations, the latter base stations may not support CBRS spectrum (non-CBSD base stations). In implementations, the latter base stations may support CBRS spectrum but expansion coverage is provided via the licensed spectrum. In implementations, the latter base stations may support CBRS spectrum and expansion coverage is provided via the licensed spectrum, the CBRS spectrum, and/or combinations thereof.

The method 14000 includes determining 14200 coverage area gaps due to CBSD coverage reduction. In response to a SAS coverage reduction message, wireless coverage areas for one or more CBSDs may be reduced. In implementations, the wireless coverage areas for one or more CBSDs may be suspended. The system can determine wireless coverage area gaps resulting from the SAS message. The system can compare the baseline wireless coverage areas with new or post-coverage reduction message wireless coverage areas (“impacted to determine the wireless coverage area gaps.

The method 14000 includes determining 14300 coverage expansion base stations. The system determines or identifies one or more base stations which can provide expanded wireless coverage to mitigate the impact of the wireless coverage area gaps and/or cover at least some portion of the wireless coverage area gaps.

The method 14000 includes establishing 14400 baseline statistics for neighbor base stations. The system identifies base stations neighboring the expansion base stations and determines baseline statistics for the neighbor base stations.

The method 14000 includes providing 14500 expansion parameters. The system sends expansion parameters to the expansion base stations to mitigate the wireless coverage area gaps. The system performs the automatic wireless coverage adjustment prior to implementation and/or execution of the SAS coverage reduction message at or by the impacted CBSD(s). That is, expansion coverage is provided proactively before the decrease in coverage and/or formation and/or occurrence of the wireless coverage gap so as to mitigate coverage issues and/or loss. The expansion parameters can be in the form of instructions, commands, and/or combinations thereof that are understood by the base stations. The base stations implement the expansion parameters by changing power levels, changing a tilt angle, and/or combinations thereof.

The method 14000 includes establishing 14600 updated baseline statistics for neighbor base stations. In implementations, the system determines the impact of the expansion parameters (post-expansion statistics) on the neighbor base stations by collecting updated statistics.

The method 14000 includes providing 14700 updated expansion parameters. In implementations, based on a comparison of the updated statistics against the baseline statistics, the system can send updated expansion parameters to appropriate ones of the expansion base stations. In implementations, updated expansion parameters are sent to expansion base stations which have a degradation in one or more statistics exceeding a defined threshold as described herein. In implementations, this update process can be done on a defined time interval, on-demand, trigger-based (i.e., a defined number of calls being dropped, quality metrics falling below a threshold, etc.), and/or combinations thereof.

The method 14000 includes restoring 14800 baseline wireless coverage areas. In implementations, in response to the SAS restoring a grant or power levels at the one or more CBSD(s), the system can restore the expansion base stations to a configuration prior to the adjustment.

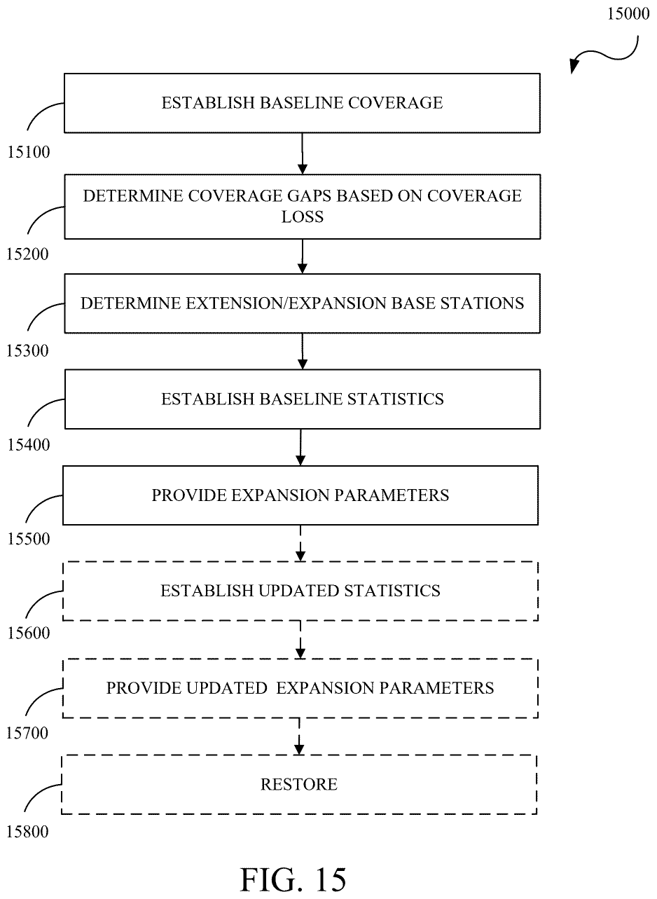

FIG. 15 is a flowchart of an example method 15000 for automatic wireless coverage adjustment in accordance with the teachings described herein. The method 15000 includes: establishing 15100 baseline wireless coverage areas; determining 15200 coverage loss; determining 15300 coverage expansion base stations; establishing 15400 baseline statistics for neighbor base stations; providing 15500 expansion parameters; establishing 15600 updated baseline statistics for neighbor base stations; providing 15700 updated expansion parameters; and restoring 15800 baseline wireless coverage areas. The method 15000 can be implemented, for example, in or by components described with respect to FIGS. 1-2 and 16 and in conjunction with any of the flows described with respect to FIGS. 3A-14, as appropriate and applicable.

The method 15000 includes establishing 15100 baseline wireless coverage areas. A system collects data from one or more OSS(es) and works with a propagation engine to determine baseline wireless coverage areas for base stations. The base stations can include CBSD(s) which support CBRS spectrum, and base stations which support licensed spectrum. In implementations, the latter base stations may not support CBRS spectrum (non-CBSD base stations). In implementations, the latter base stations may support CBRS spectrum but expansion coverage is provided via the licensed spectrum. In implementations, the latter base stations may support CBRS spectrum and expansion coverage is provided via the licensed spectrum, the CBRS spectrum, and/or combinations thereof.

The method 15000 includes determining 15200 coverage loss. The system may receive messages from a SAS and/or other components that one or more base stations are operating at lower power and/or are not transmitting at all. The system can determine wireless coverage area gaps as a result of these messages.

The method 15000 includes determining 15300 coverage expansion base stations. The system determines or identifies one or more base stations which can provide expanded wireless coverage to mitigate the wireless coverage area gaps.

The method 15000 includes establishing 15400 baseline statistics for neighbor base stations. The system identifies base stations neighboring the expansion base stations and determines baseline statistics for the neighbor base stations.

The method 15000 includes providing 15500 expansion parameters. The system sends expansion parameters to the expansion base stations to mitigate the wireless coverage area gaps. The system performs the automatic wireless coverage adjustment prior to implementation and/or execution of the coverage loss message(s). The expansion parameters can be in the form of instructions, commands, and/or combinations thereof that are understood by the base stations. The base stations implement the expansion parameters by changing power levels, changing a tilt angle, and/or combinations thereof.

The method 15000 includes establishing 15600 updated baseline statistics for neighbor base stations. In implementations, the system determines the impact of the expansion parameters on the neighbor base stations by collecting updated statistics.

The method 15000 includes providing 15700 updated expansion parameters. In implementations, based on a comparison of the updated statistics against the baseline statistics, the system can send updated expansion parameters to the expansion base stations. In implementations, this update process can be done on a defined time interval, on-demand, trigger-based (i.e., a defined number of calls being dropped, quality metrics falling below a threshold, etc.), and/or combinations thereof.

The method 15000 includes restoring 15800 baseline wireless coverage areas. In implementations, in response to messages that the one or more base stations are now fully operational, the system can restore the expansion base stations to a configuration prior to the adjustment.

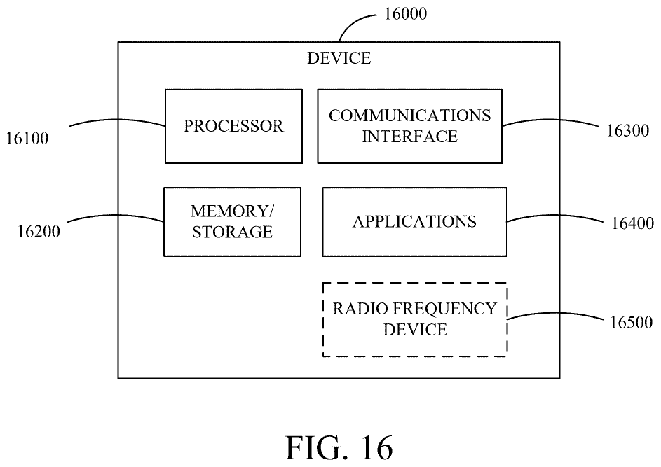

FIG. 16 is a block diagram of an example of a device 16000 in accordance with the teachings described herein. The device 16000 may include, but is not limited to, a processor 16100, a memory/storage 16200, a communication interface 16300, applications 16400, and, if needed, a radio frequency device 16500. The device 16000 may include or implement, for example, the systems and components described with respect to FIGS. 1-2 and the implement the methods of FIGS. 3A-15. The applicable or appropriate flows, techniques, or methods described herein may be stored in the memory/storage 16200 and executed by the processor 16100 in cooperation with the memory/storage 16200, the communications interface 16300, the applications 16400, and the radio frequency device 16500 (when applicable), as appropriate. The device 16000 may include other elements which may be desirable or necessary to implement the devices, systems, and methods described herein. However, because such elements and steps do not facilitate a better understanding of the disclosed embodiments, a discussion of such elements and steps may not be provided herein.

Disclosed is a method for automatically adjusting wireless coverage areas to wireless coverage gaps from a Citizens Broadband Radio Service (CBRS) power reduction or grant suspension. In implementations, a method for wireless coverage adjustment in a system with Citizens Broadband Radio Service (CBRS) includes receiving, by a coverage adjustment engine from a spectrum access system (SAS), coverage reduction messages for one or more CBRS devices (CBSDs) in a wireless network, identifying, by the coverage adjustment engine, one or more coverage expansion base stations in the wireless network to mitigate an impact of wireless coverage area gaps resulting from the coverage reduction messages, and sending, by the coverage adjustment engine to each of the one or more coverage expansion base stations, expansion parameters to adjust an associated wireless coverage area to mitigate the wireless coverage area gaps. In implementations, adjustments to one or more associated wireless coverage areas are done prior to execution of the coverage reduction messages at the one or more CBSDs. In implementations, wireless coverage area changes are implemented at a time substantially near to when the one or more base stations using a shared spectrum actually execute the requested coverage reduction message so as to lessen the impact of the wireless coverage gaps.

In implementations, the method further includes establishing, by the coverage adjustment engine with a propagation engine, baseline wireless coverage areas for base stations in the wireless network, where the base stations include at least the one or more CBSDs and the one or more coverage expansion base stations, establishing, by the coverage adjustment engine with the propagation engine, wireless coverage areas for the base stations after receipt of the coverage reduction messages, and determining, by the coverage adjustment engine, the wireless coverage area gaps by comparing the wireless coverage areas with the baseline wireless coverage areas. In implementations, the method further includes comparing, by the coverage adjustment engine, baseline wireless coverage areas with wireless coverage areas due to the coverage reduction messages to generate the wireless coverage area gaps. In implementations, the method further includes establishing, by the coverage adjustment engine with an operations support system, baseline statistics for base stations which are neighbor to the one or more coverage expansion base stations, establishing, by the coverage adjustment engine with the operations support system, post-expansion statistics for the base stations which are neighbor to the one or more coverage expansion base stations, and sending, by the coverage adjustment engine to appropriate ones of the one or more coverage expansion base stations, updated expansion parameters when one or more of the post-expansion statistics as compared to the baseline statistics exceed a defined threshold. In implementations, the expansion parameters can change at least one of a power level and a tilt angle. In implementations, the method further includes the one or more coverage expansion base stations are non-CBSDs in the wireless network. In implementations, the coverage reduction messages include grant suspension messages and power reduction messages.

Disclosed is a system including a coverage adjustment controller. The coverage adjustment controller configured to identify one or more base stations to cover wireless coverage gaps generated as a result of coverage reduction messages sent by a spectrum access system (SAS) to one or more base stations using a shared spectrum, and provide expansion parameters to the identified one or more base stations to change associated wireless coverage areas to lessen an impact of the wireless coverage gaps. In implementations, wireless coverage area changes are implemented prior to occurrence of the wireless coverage gaps.

In implementations, the coverage adjustment controller further configured to generate, prior to receipt of the coverage reduction messages, baseline wireless coverage areas for at least the identified one or more base stations and the one or more base stations using a shared spectrum, generate, post receipt of the coverage reduction messages, wireless coverage areas for the one or more base stations using the shared spectrum, and determine the wireless coverage gaps by comparing the wireless coverage areas with the baseline wireless coverage areas. In implementations, the coverage adjustment controller further configured to generate the wireless coverage gaps by comparison of baseline wireless coverage areas with wireless coverage areas due to the coverage reduction messages. In implementations, the coverage adjustment controller further configured to generate baseline statistics for one or more base stations which are neighbor to the identified one or more base stations, generate statistics for the neighboring one or more base stations, and provide updated expansion parameters to appropriate ones of the identified one or more base stations when one or more of the statistics as compared to the baseline statistics exceed a defined threshold. In implementations, the expansion parameters can change at least one of a power level and a tilt angle. In implementations, the identified one or more base stations are non-CBSDs. In implementations, the coverage reduction messages include grant suspension messages and power reduction messages. In implementations, the coverage adjustment controller includes a machine learning engine trained on at least wireless coverage area gaps, previous expansion parameters, and previous adjustments made due to statistics comparisons, and the machine learning engine configured to determine the expansion parameters due to the coverage reduction messages.

Disclosed is a method for wireless coverage adjustment in a wireless system using licensed and shared spectrum including identifying, by the coverage adjustment controller, one or more licensed spectrum base stations to lessen impact of wireless coverage area gaps resulting from coverage reduction messages received by one or more shared spectrum base stations from a spectrum access system (SAS), and providing, by the coverage adjustment controller to each of the one or more licensed spectrum base stations, expansion parameters to adjust an associated wireless coverage. In implementations, adjustments to one or more associated wireless coverage areas are done prior to execution of the coverage reduction messages at the one or more shared spectrum base stations.

In implementations, the method further includes generating, by the coverage adjustment controller, baseline wireless coverage areas for at least the one or more shared spectrum base stations and the one or more licensed spectrum base stations, generating, by the coverage adjustment controller, wireless coverage areas for the one or more shared spectrum base stations after receipt of the coverage reduction messages, and determining, by the coverage adjustment controller, the wireless coverage area gaps by comparing the wireless coverage areas with the baseline wireless coverage areas. In implementations, the method further includes comparing, by the coverage adjustment controller, baseline wireless coverage areas with wireless coverage areas due to the coverage reduction messages to generate the wireless coverage area gaps. In implementations, the method further includes establishing, by the coverage adjustment controller, baseline statistics for base stations which are neighbor to the one or more licensed spectrum base stations, establishing, by the coverage adjustment controller, post-expansion statistics for the base stations which are neighbor to the one or more one or more licensed spectrum base stations, and sending, by the coverage adjustment controller to appropriate ones of the one or more licensed spectrum base stations, updated expansion parameters when one or more of the post-expansion statistics as compared to the baseline statistics exceed a defined threshold. In implementations, the expansion parameters can change at least one of a power level and a tilt angle.

Although some teachings and/or embodiments herein refer to methods, it will be appreciated by one skilled in the art that they may also be embodied as a system or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects may take the form of a computer program product embodied in one or more the computer readable mediums having the computer readable program code embodied thereon. For example, the computer readable mediums can be non-transitory. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

As used herein, the term “computer-readable medium” encompasses one or more computer-readable media. A computer-readable medium may include any storage unit (or multiple storage units) that store data or instructions that are readable by processing circuitry. A computer-readable medium may include, for example, at least one of a data repository, a data storage unit, a computer memory, a hard drive, a disk, or a random access memory. A computer-readable medium may include a single computer-readable medium or multiple computer-readable media. A computer-readable medium may be a transitory computer-readable medium or a non-transitory computer-readable medium.

Computer program code for carrying out operations for aspects may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects are described herein with reference to flowchart illustrations and/or block diagrams of methods, apparatus (systems) and computer program products according to teachings and/or embodiments. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the figures illustrate the architecture, functionality, and operation of possible implementations of systems, methods, and computer program products according to various teachings and/or embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures.

While the disclosure has been described in connection with certain teachings and/or embodiments, it is to be understood that the disclosure is not to be limited to the disclosed teachings and/or embodiments but, on the contrary, is intended to cover various modifications, combinations, and equivalent arrangements included within the scope of the appended claims, which scope is to be accorded the broadest interpretation so as to encompass all such modifications and equivalent structures as is permitted under the law.

What is claimed is:

1. A method for wireless coverage adjustment in a system with Citizens Broadband Radio Service (CBRS), the method comprising:
receiving, by a coverage adjustment engine from a spectrum access system (SAS), coverage reduction messages for one or more CBRS devices (CBSDs) in a wireless network;
identifying, by the coverage adjustment engine, one or more coverage expansion base stations in the wireless network to mitigate an impact of wireless coverage area gaps resulting from the coverage reduction messages; and
sending, by the coverage adjustment engine to each of the one or more coverage expansion base stations, expansion parameters to adjust an associated wireless coverage area to mitigate the wireless coverage area gaps.

2. The method of claim 1, further comprising:
establishing, by the coverage adjustment engine with a propagation engine, baseline wireless coverage areas for base stations in the wireless network, wherein the base stations include at least the one or more CBSDs and the one or more coverage expansion base stations;
establishing, by the coverage adjustment engine with the propagation engine, wireless coverage areas for the base stations after receipt of the coverage reduction messages; and
determining, by the coverage adjustment engine, the wireless coverage area gaps by comparing the wireless coverage areas with the baseline wireless coverage areas.

3. The method of claim 1, further comprising:
comparing, by the coverage adjustment engine, baseline wireless coverage areas with wireless coverage areas due to the coverage reduction messages to generate the wireless coverage area gaps.

4. The method of claim 1, further comprising:
establishing, by the coverage adjustment engine with an operations support system, baseline statistics for base stations which are neighbor to the one or more coverage expansion base stations;
establishing, by the coverage adjustment engine with the operations support system, post-expansion statistics for the base stations which are neighbor to the one or more coverage expansion base stations; and
sending, by the coverage adjustment engine to appropriate ones of the one or more coverage expansion base stations, updated expansion parameters when one or more of the post-expansion statistics as compared to the baseline statistics exceed a defined threshold.

5. The method of claim 1, wherein the expansion parameters can change at least one of a power level and a tilt angle.

6. The method of claim 1, wherein the one or more coverage expansion base stations are non-CBSDs in the wireless network.

7. The method of claim 1, wherein the coverage reduction messages include grant suspension messages and power reduction messages.

8. The method of claim 1, wherein adjustments to one or more associated wireless coverage areas are done prior to execution of the coverage reduction messages at the one or more CBSDs.

9. A system, comprising:
a coverage adjustment controller configured to:
identify one or more base stations to cover wireless coverage gaps generated as a result of coverage reduction messages sent by a spectrum access system (SAS) to one or more base stations using a shared spectrum; and
provide expansion parameters to the identified one or more base stations to change associated wireless coverage areas to lessen an impact of the wireless coverage gaps.

10. The system of claim 9, the coverage adjustment controller further configured to:
generate, prior to receipt of the coverage reduction messages, baseline wireless coverage areas for at least the identified one or more base stations and the one or more base stations using a shared spectrum;
generate, post receipt of the coverage reduction messages, wireless coverage areas for the one or more base stations using the shared spectrum; and
determine the wireless coverage gaps by comparing the wireless coverage areas with the baseline wireless coverage areas.

11. The system of claim 9, the coverage adjustment controller further configured to:
generate the wireless coverage gaps by comparison of baseline wireless coverage areas with wireless coverage areas due to the coverage reduction messages.

12. The system of claim 9, the coverage adjustment controller further configured to:
generate baseline statistics for one or more base stations which are neighbor to the identified one or more base stations;
generate statistics for the neighboring one or more base stations; and
provide updated expansion parameters to appropriate ones of the identified one or more base stations when one or more of the statistics as compared to the baseline statistics exceed a defined threshold.

13. The system of claim 9, wherein the expansion parameters can change at least one of a power level and a tilt angle.

14. The system of claim 9, wherein the identified one or more base stations are non-CBSDs.

15. The system of claim 9, wherein the coverage reduction messages include grant suspension messages and power reduction messages.

16. The system of claim 9, wherein the coverage adjustment controller includes a machine learning engine trained on at least wireless coverage area gaps, previous expansion parameters, and previous adjustments made due to statistics comparisons, and the machine learning engine configured to determine the expansion parameters due to the coverage reduction messages.

17. The system of claim 9, wherein wireless coverage area changes are implemented at a time substantially near to when the one or more base stations using a shared spectrum actually execute the requested coverage reduction message so as to lessen the impact of the wireless coverage gaps.

18. A method for wireless coverage adjustment in a wireless system using licensed and shared spectrum, the method comprising:
identifying, by the coverage adjustment controller, one or more licensed spectrum base stations to lessen impact of wireless coverage area gaps resulting from coverage reduction messages received by one or more shared spectrum base stations from a spectrum access system (SAS); and
providing, by the coverage adjustment controller to each of the one or more licensed spectrum base stations, expansion parameters to adjust an associated wireless coverage.

19. The method of claim 18, further comprising:
generating, by the coverage adjustment controller, baseline wireless coverage areas for at least the one or more shared spectrum base stations and the one or more licensed spectrum base stations;
generating, by the coverage adjustment controller, wireless coverage areas for the one or more shared spectrum base stations after receipt of the coverage reduction messages; and
determining, by the coverage adjustment controller, the wireless coverage area gaps by comparing the wireless coverage areas with the baseline wireless coverage areas.

20. The method of claim 18, further comprising:
comparing, by the coverage adjustment controller, baseline wireless coverage areas with wireless coverage areas due to the coverage reduction messages to generate the wireless coverage area gaps.

21. The method of claim 18, further comprising:
establishing, by the coverage adjustment controller, baseline statistics for base stations which are neighbor to the one or more licensed spectrum base stations;
establishing, by the coverage adjustment controller, post-expansion statistics for the base stations which are neighbor to the one or more one or more licensed spectrum base stations; and
sending, by the coverage adjustment controller to appropriate ones of the one or more licensed spectrum base stations, updated expansion parameters when one or more of the post-expansion statistics as compared to the baseline statistics exceed a defined threshold.

22. The method of claim 18, wherein the expansion parameters can change at least one of a power level and a tilt angle.

23. The method of claim 18, wherein adjustments to one or more associated wireless coverage areas are done prior to execution of the coverage reduction messages at the one or more shared spectrum base stations.
